(19) United States
(12) Patent Application Publication
(10) Pub. No.: US 2022/0176326 A1
(43) Pub. Date: Jun. 9, 2022

(54) FIBRE COMPRISING ORGANOSILANE FOR PURIFICATION OF LIQUIDS

(71) Applicant: Conopco, Inc., d/b/a UNILEVER, Englewood Cliffs, NJ (US)

(72) Inventors: Swarnaditya HAZRA, Howrah (IN); Udayan MAJUMDAR, Bangalore (IN); Venkataraghavan RAJANARAYANA, Bangalore (IN); Priyanka SARKAR, Kolkata (IN); Himadri SEKHAR KUMAR, Uluberia (IN)

(73) Assignee: Conopco, Inc., d/b/a UNILEVER, Englewood Cliffs, NJ (US)

(21) Appl. No.: 17/612,660

(22) PCT Filed: May 14, 2020
(86) PCT No.: PCT/EP2020/063411

§ 371 Date: Nov. 19, 2021

(30) Foreign Application Priority Data
May 27, 2019 (EP) 19176656.7

(51) Int. Cl. B01D 69/08; D01D 5/06; B01D 69/14; D01D 5/24; D01F 1/10

(52) U.S. Cl. CPC B01D 69/088; D01D 5/06; B01D 69/148; D01D 5/24; B01D 71/68; B01D 2325/02; B01D 2323/46; B01D 2325/48; B01D 2325/20; D01F 1/103

(57) ABSTRACT

The present invention relates to a fibre for purification of liquids comprising a matrix of polymer with organosilane impregnated therein and a method for preparing the same. The fibre of the present invention is capable of providing at least 2 log reduction of viruses, bacteria and cysts and flux of 10 to 1000 litre per square meter per hour at 2 psig.

### FIELD OF THE INVENTION

The present invention relates to a fibre for purification of liquids. More particularly the invention relates to an organosilane impregnated fibre capable of providing protection against bacteria and viruses. The invention more particularly relates to a hollow fibre membrane.

### BACKGROUND OF THE INVENTION

Water usually contains three types of impurities. The first is suspended or particulate matter; dissolved chemicals come next, followed by microorganisms. Bacteria, viruses and cysts are the most common microbial contamination in water and are responsible for millions of deaths each year. Water purification processes that successfully eliminate bacteria, viruses and cysts from water sources can be expensive. The purification methods include use of chemicals and radiation. It is desired to find effective, low cost technologies to eliminate this type of contamination.

Microfiltration is a known technology utilized for water purification. Microfiltration membrane separates particles on the basis of size, by passing a solution or suspension through a fine pore-sized filter. Microfiltration membrane is generally a tough, thin, selectively permeable membrane that retains most macromolecules and or particles above a certain size, including most bacteria. Microfiltration membranes, however, cannot be used to exclude particles or organisms smaller than the filter pore size, like viruses. Viruses can however be removed from feed solutions by ultrafiltration, nanofiltration or reverse osmosis. These types of membrane filtration techniques require costly materials and high pressure operations.

Improvements in filters that can effectively remove viruses and can retain the benefits of low pressure operation, remain desirable.

U.S. Pat. No. 6,652,751B1 (Kutowy et al., 2003) discloses a polymer membrane incorporated with metal which prevents colonization of membrane surfaces by microorganisms when processing water. The metals incorporated include silver, copper, tin, nickel and other metals and/or mixtures and alloys. The metal is synthesised in situ by reducing the metal ion incorporated into the membrane with a reducing agent. However, using a reducing agent may cause degradation of membrane structure and irreversible changes in its porous morphology leading to reduced permeability or occurrence of structural defects.

U.S. Pat. No. 5,102,547 (Waite et al., 1992) discloses a synthetic polymer membrane incorporating fine particles of water-insoluble bioactive material example metal and metal alloys dispersed in the polymer matrix.

WO2014/016082 A1 (Unilever) discloses a filter media for significantly greater log reduction of bacteria in water. The unitary filter media has copper hydroxide and silver compound incorporated therein.

A challenge faced by the present inventors is to provide safe water which is free from viruses while providing high flow rates.

This challenge was overcome by WO2016/131754A1 (Unilever) by providing a filter for purification of liquids which could achieves at least 2 log reduction of viruses, bacteria or cysts. This invention provided a filter for purification of liquids having a fibrous support composed of fibres and a matrix of polymer with copper impregnated therein characterised in that the matrix of polymer is superimposed on the surface of the fibres.

This requires a filter support for bacteria rejection and copper impregnation for virus removal which is a two-step process to achieve the said results. Therefore, the problem with such filter is that a fibrous support composed of fibres is required which increases the process complexity and costs of making a filter to provide 2 log reduction of viruses, bacteria or cysts.

Our co-pending Application (EP18184813.6) also discloses functional fibre for purification of liquids comprising a matrix of polymer with copper impregnated therein, however as copper is insoluble in dope, an extra unit is required for the operation of stirring and change in spinneret design to bring down the pressure drop while extruding Cu impregnated hollow fibre membrane.

Therefore, now there is a need to provide a fibre comprised of such fibres which provides at least 2 log reduction of viruses, bacteria or cysts without use of any halogens or chemicals in low pressure energy saving device including operation at gravity driven pressures, and at significantly lower cost. Also, a fibre which is not only efficacious in purification of liquids but also in ease, speed and cost of manufacturing.

### SUMMARY OF THE INVENTION

According to a first aspect is disclosed a fibre for purification of liquids comprising a matrix of polymer with organosilane impregnated therein, wherein the pore size of fibre is in the range of 0.01 to 1.0 micrometer.

According to a second aspect is disclosed a method of preparing a fibre of the first aspect, the method comprising the steps of:
(i) preparing a solution of a polymer and pore forming agent in a solvent and adding first antisolvent, the first antisolvent comprising the organosilane biocide;
(ii) extruding the suspension of step (i) through an extrusion means and simultaneously contacting a second antisolvent to the inner side of the fibres to obtain a hollow fibre membrane.
(iii) immersing the hollow fibre membrane of step (ii) in a third antisolvent to precipitate the polymer to form a matrix of polymer with organosilane biocide impregnated therein to obtain a fibre for purification of liquids.

According to a third aspect of the disclosed invention is provided a filter comprising fibres according to the first aspect or obtainable by a process of the second aspect.

According to a fourth aspect of the present invention disclosed use of a fibre for purification of liquids comprising a matrix of polymer with organosilane impregnated therein, wherein the pore size of fibre is in the range of 0.01 to 1.0 micrometer, for providing at least 2 log reduction of bacteria, viruses or cysts.

According to a further aspect of the present invention disclosed is use of a fibre for purification of liquids comprising a matrix of polymer with organosilane impregnated therein, wherein the pore size of fibre is in the range of 0.01 to 1.0 micrometer, for providing flux in the range of 10-1000 litre per square meter per hour at 2 psig.

These and other aspects, features and advantages will become apparent to those of ordinary skill in the art from a reading of the following detailed description and the appended claims.

### DETAILED DESCRIPTION OF THE INVENTION

For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se.

Except in the operating and comparative examples, or where otherwise explicitly indicated, all numbers in this description indicating amounts of material or conditions of reaction, physical properties of materials and/or use are to be understood as modified by the word “about”.

Numerical ranges expressed in the format “from x to y” are understood to include x and y. When for a specific feature multiple preferred ranges are described in the format “from x to y”, it is understood that all ranges combining the different endpoints are also contemplated.

As used herein, the indefinite article “a” or “an” and its corresponding definite article “the” means at least one, or one or more, unless specified otherwise.

Throughout the description, the term “log reduction” as used herein means a 10-fold or 90% reduction in the number of viable microorganisms. By “2 log” reduction it is meant that the number of viable bacteria is reduced by 99%. By “4 log” reduction it is meant that the number of viable bacteria is reduced by 99.99%.

The present invention provides a fibre for purification of liquids comprising a matrix of polymer with an organosilane impregnated therein.

For the purposes of this invention the word ‘impregnate’ is meant to be understood as a substance being incorporated into the hollow fibre membrane during the process of formation of the fibre.

The invention does not require a filter support for bacteria rejection, but the fibre of the present invention in itself functions to reject bacteria, virus and cysts.

The present invention also provides a filter which is comprised of the fibres comprising a matrix of polymer with organosilane impregnated therein, wherein the pore size of fibre is in the range of 0.01 to 1.0 micrometer.

This filter is preferably capable of providing flux in the range of 10 to 1000 litre per square meter per hour more preferably 50 to 400 at 2 psig; and providing at least 2 log reduction and more preferably 4 log reduction of bacteria, viruses and cysts.

As it is known that a Microfiltration membrane rejects bacteria and cysts by virtue of its membrane morphology, but it cannot remove virus, on the other hand an ultrafiltration membrane rejects virus but cannot function at low pressures, and therefore, cannot work in gravity filtration devices. The inventors of the present invention surprisingly found that the fibre of the invention helps provides permeability like a microfiltration membrane and is able to function at low pressures and has selectivity like that of an ultrafiltration membrane to be able to reject virus. Further, the process of the present invention allows the composition to be extruded in a single phase dope which is convenient, fast and economic as compared to any other fibre such as copper impregnated fibre.

Fibre

The fibre of the present invention, suitable for purification of liquids comprises a matrix of polymer with organosilane impregnated therein, wherein the pore size of fibre is in the range of 0.01 to 1.0 micrometer, more preferably from 0.05 to 0.8 micrometer and most preferably from 0.1 to 0.5 micrometer. Herein throughout the description of the present invention, pore size of the fibre refers to pore size of wall of the fibre.

The polymer is preferably a thermoplastic polymer. Thermoplastic polymers are polymers that soften when exposed to heat and return to their original condition when cooled to room temperature.

Disclosed matrix of polymer is preferably prepared from any one of the polymer selected from, polyacrylonitriles, polyamides, polyolefins, polyesters, polysulfones, polyethersulfones, polyether ketones, sulfonated polyether ketones, polyamide sulfones, polyvinylidene fluorides, and other chlorinated polyethylenes, polystyrenes and polytetrafluorethylenes or mixtures thereof. More preferred polymers are polyolefins, polyester, polyacrylates, polysulfones, polyvinylidenefluoride, aromatic polysulfones, aromatic polyphenylene-sulfones, aromatic polyethersulfones, polyamide, and their copolymers. It is still preferred that the polymer is selected from polyamides, polyacrylonitriles, polysulfones, polyethersulfones, polyvinylidenefluoride or a mixture thereof. Polysulfones, polyethersulfone, polyvinylidenefluoride are the most preferred.

Organosilane

Monomeric silicon chemicals are known as silanes. A silane that contains at least one carbon-silicon bond (Si—C) structure is known as an organosilane. The common use of organosilane is as microbiocide and hydrophobic agent. The organosilane is soluble in ethanol. Preferably organosilane is selected from the group of Octadecyl Dimethyl (3-Triethoxy silyl propyl) Ammonium Chloride, Octadecyl Dimethyl (3-Trimethoxy silyl propyl) Ammonium Chloride and Octadecyl Dimethyl (3-Trihydroxy silyl propyl) Ammonium Chloride.

Method of Preparing the Disclosed Fibre

In a second aspect of the present invention disclosed is a method of preparing the fibre of the first aspect including the steps of:
(i) preparing a solution of a polymer and pore forming agent in a solvent and adding first antisolvent, the first antisolvent comprising the organosilane biocide;
(ii) extruding the suspension of step (i) through an extrusion means and simultaneously contacting a second antisolvent to the inner side of the fibres to obtain a hollow fibre membrane.
(iii) immersing the hollow fibre membrane of step (ii) in a third antisolvent to precipitate the polymer to form a matrix of polymer with organosilane biocide impregnated therein to obtain a fibre for purification of liquids.

It is preferred that the extrusion means is a spinneret.

To begin with, the method of preparing the fibre includes the step of preparing a solution of a polymer and pore forming agent in a solvent and adding first anti solvent comprising the organosilane biocide.

The solvent is preferably selected from N-methylpyrrolidone, dimethylformamide, dimethyl sulphoxide, dimethylacetamide or mixtures thereof. Dimethylacetamide is the most preferred. Preferably the ratio of the amount of the solvent to the polymer is 2:1 to 10:1, more preferably 3:1 to 8:1 and most preferably 4:1 to 6:1.

The pore forming agent is preferably selected from polyvinylpyrrolidone (PVP), polyethylene glycol (PEG), polyvinyl alcohol (PVA) or mixtures thereof. It is highly preferred that the pore forming agent is polyvinyl pyrrolidone (PVP). It is highly desired that the pore forming agent is added to the solution such that the ratio of the amount of the pore forming agent to the amount of the polymer is 1:1 to 1:5 more preferably 1:1.5 to 1:3 more preferably 1:1.7 to 1:2. The pore forming agent is preferably soluble in the solvent and preferably also the second and third antisolvent. The pore forming agent preferably dissolves in the second and third antisolvent which preferably results in the pores formed within the matrix of polymer.

The first antisolvent is preferably selected from alcohol, polyol, ketone, water or a mixture thereof and is preferably used for dissolving organosilane into the dope and making dope composition preferably close to cloud point. The preferred first antisolvent is Ethanol.

The next step involves extruding the suspension through preferably a spinneret and simultaneously contacting a second antisolvent to the inner side of the fibres to obtain a hollow fibre membrane.

The second antisolvent is preferably dimethylacetamide and water mixture. The second antisolvent is a non-solvent of the polymer and the polymer precipitates in a controlled way to form a matrix of polymer with the organosilane impregnated therein. The dimethylacetamide and water mixture is preferably maintained at a temperature of between 0° C. to 70° C. The pore forming agent is soluble in the solvent and the second antisolvent. The pore forming agent dissolves in the second antisolvent forming desired pores in the coated matrix of polymer.

The hollow fibre membranes are then immersed in a third antisolvent to preferably washout the pore forming agent and the solvent and first antisolvent and simultaneously precipitating the polymer to form a matrix of polymer with organosilane impregnated therein. It is preferred that the fibre is then washed with room temperature water and then dried.

The second and third antisolvents are selected from n-methyl pyrrolidone, dimethylformamide, dimethyl sulphoxide, dimethylacetamide, combinations and mixtures thereof and antisolvent selected from Alcohol, Polyol, Ketone, Water, combinations and mixture thereof.

Method of Preparing the Disclosed Filter

The fibre as disclosed in the present invention is unique in itself that it neither needs a support fibre nor any other filter, membrane or fibre downstream to achieve 2 log reduction of bacteria, viruses or cysts. It may be formed into a filter according to the well known industry standards.

However, in a preferred aspect required number of fibres can be cut in desired length, then bended in U-shape and tied. The U-shape fibres can be then potted in a plastic cup using a mixture of resin and hardener. The fibre openings could be first sealed using a sealant before potting to prohibit resin or hardener entry inside fibre inner diameter. The potted module could then be allowed to harden, then cut from other side to open fibre inner diameter. The module could then be used for further testing.

It is preferred that filters are made by making fibres by varying the ratio of organosilane to polymer in the range of 0.1:1 to 1:1, more preferably in the range of 0.2:1 to 0.7:1 and most preferably in the range of 0.3:1 to 0.5:1.

It is preferred that the dope solution is preferably passed through the annular space of preferably a spinneret preferably using an applied pressure of 2 to 10 bar according to viscosity and dope flow rate. Preferably bore fluid or the second antisolvent which is the fluid passed through inner surface to create hollowness in fibre. The second antisolvent is preferably with a varying composition of dimethylacetamide (50-100% of mixture) and RO water mixture, was passed through preferably the inner diameter of spinneret preferably using a gear pump to form hollowness in the membranes.

Preferably the bore fluid flow rate was kept 1:1 with dope fluid flow for getting right morphology. Preferably the typical dope fluid flow rate is 5 to 50 ml/min and more preferably 5 to 30 ml/min. Preferably once the dope fluid contacts the bore fluid from inner side, the phase separation preferably gets started at inner layer as per non-solvent induced phase separation (NIPS) process. Then preferably the extruded semi solid hollow fibre membranes are kept for some time in air (air gap) before preferably passing through a coagulation bath comprising of third antisolvent preferably RO water at preferably a temp. of 25 to 65° C. and more preferably 35 to 45° C. Preferably the residence time in coagulation bath was couple of minutes and then preferably the membranes got rolled in a maturation bath. The maturation bath preferably also comprises of RO water at preferably of 25 to 65° C. and more preferably 35 to 45° C.

The morphology and final diameter/membrane thickness is preferably then altered by rolling speed in maturation bath. The membranes roll is then preferably maturated for 12 hrs to solubilize DMAc, PVP and Ethanol. Later the membranes are preferably washed with room temperature water to ensure complete removal of solvent from membrane surface. Then the membranes are preferably air dried and potted as module.

Water Purification Device

According to a third aspect of the disclosed invention is provided a water purification device comprising a filter comprised of the fibres according to the first aspect.

Use

According to a fourth aspect of the present invention disclosed is the use of a fibre of the first aspect or a device of the third aspect for providing at least 2 log reduction, and more preferably at least 2 log reduction of viruses. According to a further aspect of the present invention disclosed is the use of a fibre of the first aspect or a device of the third aspect for providing flux of 10 litres per square meter per hour to 1000 litres per square meter per hour at 2 psig pressure and still more preferably from 50 litres per square meter per hour to 400 litres per square meter per hour at 2 psig pressure.

### EXAMPLES

The disclosure, having been generally described, may be more readily understood by reference to the following examples, which are included merely for purposes of illustration of certain aspects and embodiments of the present disclosure, and are not intended to limit the disclosure in any way.

### Example 1: Preparation of a Filter According to the Present Invention

Dope Preparation

Air dried Polysulfone and PVP with required quantity were dissolved in DMAc at 65° C.

Then required amount of organosilane ethanol solution (known as first antisolvent) was added in another DMAc at 45° C. temperature. The first antisolvent was then added slowly to Polysulfone, PVP DMAc solution at temperature of 50-55 OC until cloudiness appears. When the cloudiness permanently persists, the addition was stopped as the dope reached its cloud point. The dope was allowed to cool down overnight to become clear solution again and ready to be used to extrude the membrane.

Extrusion of Organosilane Embedded HFM

Dope solution was passed through the annular space of spinneret using an applied pressure of 2-3 bar. Bore fluid with a composition of 80% DMAc and 20% RO water was passed through the inner diameter of spinneret using a gear pump to form hollowness in the membranes. The bore fluid flow rate was kept 1:1 with dope fluid flow for getting right morphology. The typical dope fluid flow rate was 10 ml/min. Once the dope fluid contacted bore fluid from inner side, the phase separation got started at inner layer as per Non-solvent induced phase separation (NIPS) process. Then the extruded semi solid hollow fibre membranes were spent some time in air (air gap) before passing through a coagulation bath comprising of RO water at temp. of 40 OC. The residence time in coagulation bath was couple of minutes and then got rolled in a maturation bath. The maturation bath was also comprising of RO water at 40° C. The morphology and final diameter/membrane thickness was altered by rolling speed in maturation bath. The membranes roll was then maturated for 12 hrs to solubilize DMAc, PVP and Ethanol. Later the membranes were washed with normal RO water three times to ensure complete removal of solvent from membrane surface. Then the membranes were air dried and potted as module for further testing.

### Example 2: Evaluation of the Removal of Bacteria and Virus Using a Cartridge Having a Filter According to the Present Invention

NSF P231 protocol was followed for bacteria and virus testing. Test water loaded with ˜5 log virus and ˜7 log bacteria was used for testing. MS2 bacteriophage was taken as a representative virus and Escherichia coli was taken as the representative for bacteria.

Filtration of Test Water

The filter module prepared according to Example 1 was fixed in the filtration assembly of a top chamber and passed 10 litres of spiked water under gravity head. The output sample was collected after 2 litres of water passed for microbial testing.

Method/Protocol for Flux Measurement

Single strand fibre was potted and used for flux measurement. Single strand potted fibre was first connected to a confined vessel filled with water, then pressure was applied to the water inside vessel. The water flowrate across single strand fibre was measured at different pressure. The flux was obtained by calculating water flowrate (litre/hr) per unit area (square meter) of fibre at a particular pressure (psig).

TABLE 1

| | | Biocide | Perme- | Microbial reduction | |
|---|---|---|---|---|---|
| | Incor- | to | ability, | Virus | Bacteria |
| Filter | porated | Polysulfone | LMH at 2 | Log | Log |
| configuration | biocide | (w/w) | psig | Removal | Removal |
| HFM | Nil | 0% | 400 | 0.46 | 7 |
| Organosilane: | Organo | 30% | 200 | 5 | 7 |
| HFM 1 | quaternary | | | | |
| | silane | | | | |
| Organosilane: | Organo | 50% | 200 | 5 | 7 |
| HFM 2 | quaternary | | | | |
| | silane | | | | |

It can be noted from Table 1 that controlled Hollow Fibre Membrane (HFM) gave 7 log bacteria rejection due to virtue of size but failed to remove virus as expected. The present invention having HFM with Organosilane is not only capable of removing 7 log of bacteria but also shows high performance (>4 log) in removing virus without compromising the flux significantly.

1. A hollow fibre for purification of liquids comprising a matrix of polymer with organosilane impregnated therein, wherein the fibre has a pore size from 0.01 to 1.0 micrometer; wherein total organosilane to total polymer content ranges from 0.1:1 to 1:1 by weight.

2. The fibre according to claim 1, wherein the polymer is selected from polyamides, polyacrylonitriles, polysulfones, polyethersulfone, polyvinylidenefluoride or a mixture thereof.

3. The fibre according to claim 1 wherein the organosilane is selected from Octadecyl Dimethyl (3-Triethoxy silyl propyl) Ammonium Chloride or Octadecyl Dimethyl (3-Trimethoxy silyl propyl) Ammonium Chloride or Octadecyl Dimethyl (3-Trihydroxy silyl propyl) Ammonium Chloride.

4. A method of preparing a hollow fibre according to claim 1, the method comprising the steps of:
(i) preparing a solution of a polymer and pore forming agent in a solvent and adding first antisolvent, the first antisolvent comprising the organosilane biocide;
(ii) extruding the suspension of step (i) through an extrusion means and simultaneously contacting a second antisolvent to the inner side of the fibres to obtain a hollow fibre membrane;
(iii) immersing the hollow fibre membrane of step (ii) in a third antisolvent to precipitate the polymer to form a matrix of polymer with polymer biocide impregnated therein to obtain a fibre for purification of liquids.

5. The method according to claim 4, wherein the pore forming agent to the polymer ranges from 1:1 to 1:5 by weight.

6. The method according to claim 4, wherein the solvent to the polymer ranges from 2:1 to 10:1 by weight.

7. The method according to claim 4, wherein the pore forming agent is selected from polyvinylpyrrolidone (PVP), polyethylene glycol (PEG), polyvinyl alcohol (PVA) or mixtures thereof.

8. The method according to claim 4, wherein the solvent is selected from N-methylpyrrolidone, dimethylformamide, dimethyl sulphoxide, dimethylacetamide or mixtures thereof.

9. The method according to claim 4, wherein the first antisolvent is an alcohol.

10. The method according to claim 4, wherein the second and third antisolvents are selected from N-methylpyrrolidone, dimethylformamide, dimethyl sulphoxide, dimethylacetamide or mixtures thereof and antisolvent selected from alcohol, polyol, ketone, water, combinations and mixtures thereof.

11. The method according to claim 4, wherein the extrusion means is a spinneret.

12. A filter for purification of liquids, the filter comprising hollow fibres according to claim 1.

13. The hollow fibre according to claim 1, wherein the fibre provides at least a 2 log reduction of bacteria, viruses and cysts.

14. The hollow fibre according to claim 1, wherein the fibre provides a flux in a range of 10 to 1000 litre per square meter per hour at 2 psig.
